(19) United States
(12) Patent Application Publication
(10) Pub. No.: US 2026/0339509 A1
(43) Pub. Date: Oct. 29, 2026

(54) METHOD, ELECTRONIC DEVICE, AND COMPUTER PROGRAM PRODUCT FOR STORAGE

(71) Applicant: Dell Products L.P., Round Rock, TX (US)

(72) Inventor: Weibing Zhang, Beijing (CN)

(21) Appl. No.: 19/211,596

(22) Filed: May 19, 2025

(30) Foreign Application Priority Data
Apr. 25, 2025 (CN) 202510530312.1

(51) Int. Cl. G06F 3/06

(52) U.S. Cl. CPC G06F 3/0604; G06F 3/0653; G06F 3/0673

(57) ABSTRACT

A method in one embodiment includes retrieving a data record corresponding to target data in response to a request for the target data, wherein at least a part of the target data is moved from a tier of a first heat level to a tier of a second heat level of a storage system in response to a change in data heat, the first heat level being higher than the second heat level. The method also includes determining the tier of the first heat level in the storage system where the target data was stored when used in history, and moving the at least a part of the target data to the tier of the first heat level. The method provides a record-based cross-tier data movement strategy, which can restore a desired data tiered layout according to the data record when repeated workloads need to use stored data again.

### RELATED APPLICATION

The present application claims priority to Chinese Patent Application No. 202510530312.1, filed Apr. 25, 2025, and entitled “Method, Electronic Device, and Computer Program Product for Storage,” which is incorporated by reference herein in its entirety.

### FIELD

Embodiments of the present disclosure relate generally to the field of storage, and more specifically, relate to a method, an electronic device, and a computer program product for storage.

### BACKGROUND

A storage system may be a collection of storage hardware and software configured to access and manage data. From a hardware perspective, the storage system covers storage devices used to persist data, providing storage space for data. In addition, from a software perspective, the storage system ensures data access efficiency and security by organizing and arranging data, classifying and indexing data, and managing permissions.

The storage system may include multiple different types of storage devices. For example, a storage device based on a solid state drive (SSD), a storage device based on a hard disk drive (HDD), or a storage device based on a combination of the two. These different types of storage devices work together to provide efficient and reliable data access services, where different storage media have their own characteristics and applicable scenarios.

### SUMMARY

Embodiments of the present disclosure provide a solution for storage.

In a first aspect of the present disclosure, a method for storage is provided. The method includes retrieving a data record corresponding to target data in response to a request for the target data, wherein at least a part of the target data is moved from a tier of a first heat level to a tier of a second heat level of a storage system in response to a change in data heat, the first heat level being higher than the second heat level. The method also includes determining the tier of the first heat level in the storage system where the target data was stored when used in history. The method also includes moving the at least a part of the target data to the tier of the first heat level.

In another aspect of the present disclosure, an electronic device is provided, including a processor and a memory coupled to the processor and having instructions stored thereon, wherein the instructions, when executed by the processor, cause the electronic device to perform actions including: retrieving a data record corresponding to target data in response to a request for the target data, wherein at least a part of the target data is moved from a tier of a first heat level to a tier of a second heat level of a storage system in response to a change in data heat, the first heat level being higher than the second heat level. These actions further include determining the tier of the first heat level in the storage system where the target data was stored when used in history. These actions further include moving the at least a part of the target data to the tier of the first heat level.

In still another aspect of the present disclosure, a computer program product is provided. The computer program product is tangibly stored on a non-transitory computer-readable storage medium and includes machine-executable instructions that, when executed by a machine, cause the machine to perform a method or process according to embodiments of the present disclosure.

It should be noted that this Summary is provided to introduce a series of concepts in a simplified manner, and these concepts will be further described in the Detailed Description below. The Summary is neither intended to identify key features or necessary features of the present disclosure, nor intended to limit the scope of the present disclosure.

### BRIEF DESCRIPTION OF THE DRAWINGS

By description of embodiments of the present disclosure, provided in further detail with reference to the accompanying drawings, the above and other objectives, features, and advantages of the present disclosure will become more apparent, in which:

FIG. 1A is a schematic diagram of an example environment in which a method and/or a process according to an embodiment of the present disclosure may be implemented;

FIG. 1B is a schematic diagram of an example of a storage pool according to an embodiment of the present disclosure;

FIG. 2 is a flow chart of a method for storage according to an embodiment of the present disclosure;

FIG. 3 illustrates an example of a moving process of a record-based cross-tier data movement strategy according to an embodiment of the present disclosure;

FIG. 4 shows an example of a data record according to an embodiment of the present disclosure;

FIG. 5 shows another example of a data record according to an embodiment of the present disclosure;

FIG. 6 illustrates an example of a record-based restore process of a data tiered layout according to an embodiment of the present disclosure;

FIG. 7 illustrates an example of a record-based data back migration process according to an embodiment of the present disclosure; and

FIG. 8 is a block diagram of an example device that can be used to implement embodiments of the present disclosure.

Throughout all the drawings, the same or similar reference numerals generally represent the same or similar elements.

### DETAILED DESCRIPTION

Illustrative embodiments of the present disclosure will be described below in further detail with reference to the accompanying drawings. Although certain embodiments of the present disclosure are illustrated in the accompanying drawings, it should be understood that the present disclosure can be implemented in various forms and should not be construed as being limited to the embodiments set forth herein. Rather, these embodiments are provided for more thorough and complete understanding of the present disclosure. It should be understood that the accompanying drawings and embodiments of the present disclosure are for illustrative purposes only, and are not intended to limit the protection scope of the present disclosure.

In the description of embodiments of the present disclosure, the term “including” and its variations should be understood as open-ended inclusion, i.e., “including but not limited to.” The term “based on” should be understood as “based at least in part on.” The term “one embodiment” or “the embodiment” should be understood as “at least one embodiment.” The terms “first,” “second,” and the like may refer to different or identical objects, unless otherwise specifically indicated.

As mentioned above, a storage system is a collection of hardware and software that stores and manages data. Storage devices in the storage system may not have consistency, and may include, for example, SSD-based storage devices, HDD-based storage devices, or storage devices based on a combination of the two. Different types of storage devices can work together in the storage system, where different storage media have their own characteristics and applicable scenarios.

The storage system may be based on an automatic tiering mechanism, for example, an automatic tiering strategy, a high performance first then automatic tiering strategy, and the like. The storage system based on the automatic tiering mechanism (also referred to as an automatic tiered storage system herein) can direct or redirect storage data to corresponding storage resources according to the activity level of the storage data, thereby achieving optimal configuration of storage resources.

When using the storage data, tasks are often enabled with an optimized data layout to speed up a job. For example, the storage data may be located in a storage area with higher access performance (e.g., with relatively high read and write speeds) in the storage system, rather than in a storage area with lower access performance. Data movement of the storage data between tiers is managed by automatic tiering algorithms and/or strategies. After the tasks are completed, the tiered layout of the storage data may have changed due to the automatic tiering mechanism. For example, because the heat of the entire or a part of the storage data decreases, the data is moved to a tier with a lower heat level. The access performance of the tier with the lower heat level is lower (e.g., it has relatively low read and write speeds). When repeated workloads need to use the storage data again, input/output (I/O) performance may degrade during repeated jobs because the optimal tiered layout of the storage data has been changed.

In order to solve at least some of the above and other potential problems, embodiments of the present disclosure provide a solution for storage. The solution includes retrieving a data record corresponding to target data in response to a request for the target data, wherein at least a part of the target data is moved from a tier of a first heat level to a tier of a second heat level of a storage system in response to a change in data heat, the first heat level being higher than the second heat level. The solution also includes determining the tier of the first heat level in the storage system where the target data was stored when used in history. The solution also includes moving the at least a part of the target data to the tier of the first heat level. In this way, a record-based cross-tier data movement strategy is provided, which can restore a hierarchical layout according to the data record when repeated workloads need to use the storage data again, thereby speeding up data access.

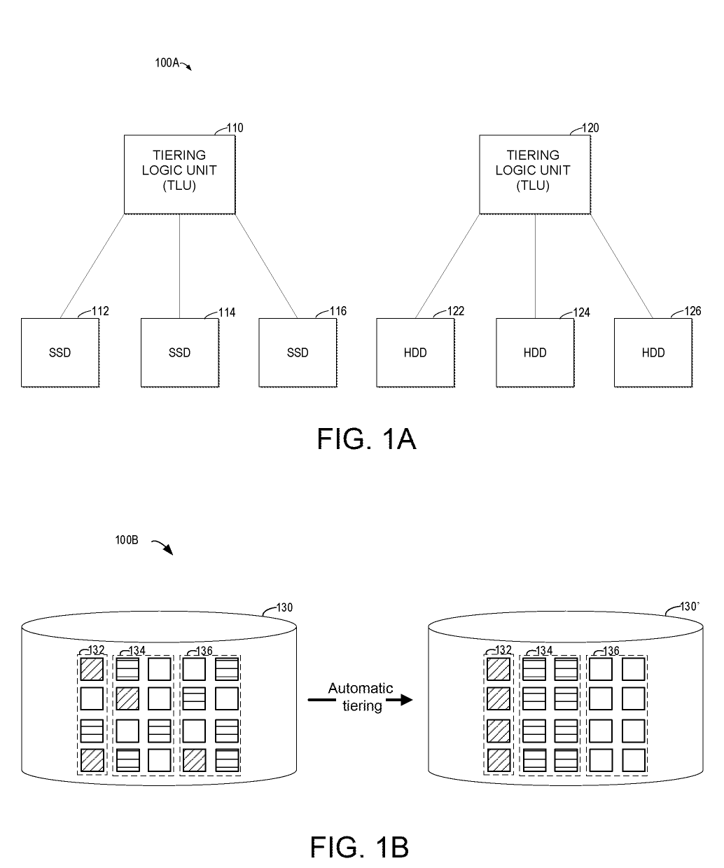

Basic principles and some example implementations of the present disclosure will be illustrated below with reference to FIGS. 1A-8. It should be understood that these example embodiments are provided merely to enable those skilled in the art to better understand and then implement embodiments of the present disclosure, and are not intended to impose any limitation on the scope of the present disclosure.

FIG. 1A shows a schematic diagram of an example environment 100A in which a method and/or a process according to an embodiment of the present disclosure can be implemented. The example environment 100A shows, by way of example and not limitation, a hardware configuration in a storage system, where the storage system may include different types of storage devices. As schematically shown in FIG. 1A, the storage system may include SSDs 112-116 and HDDs 122-126.

The SSDs 112-116 may be coupled to a tiering logic unit (TLU) 110, and the HDDs 122-126 may be coupled to a TLU 120, so that a holistic continuous storage space can be presented to a user side without revealing the specific distribution of the storage devices in the system. The TLU may be configured to form a scalable logic unit with storage devices coupled thereto. For example, the SSD 112 and the SSD 114 may not be geographically located in the same place, but for users, a storage space formed by the SSD 112 and the SSD 114 is like a seamless whole. No matter when and where the users perform data read and write operations, there is no need to worry about which specific physical device data is stored on, and the users only need to focus on the use of the data itself.

As shown in FIG. 1A, two types of storage devices are shown, namely, SSD-based storage devices (i.e., SSDs 112-116) and HDD-based storage devices (i.e., HDDs 122-126). It should be understood that the storage system according to embodiments of the present disclosure is not limited to a two-tier storage system, but can also be composed of more types of storage devices, such as a three-tier storage system composed of flash-based storage devices, serial attached SCSI interface (SAS)-based storage devices, and near-line SAS (NL-SAS)-based storage devices. Furthermore, the number of each type of storage devices in the storage system may be the same or different, and embodiments of the present disclosure are not limiting in this respect.

FIG. 1B shows a schematic diagram of an example 100B of a storage pool according to an embodiment of the present disclosure. Based on the hardware configuration of the storage system, a logic storage pool may be constructed, as shown in the example 100B of FIG. 1B. FIG. 1B shows data of three data heats in an illustrative and non-limiting manner, i.e., first data with the highest data heat identified by blocks with slant crossed lines, second data with the second highest data heat identified by blocks with horizontal crossed lines, and third data with relatively low data heat identified by blank blocks, wherein each block indicates a storage management unit (e.g., a slice) of the storage system, which has a fixed unit size.

As schematically shown in FIG. 1B, a storage pool 130 may indicate the distribution of the respective data thereon before automatic tiering, wherein a tier 132 may correspond to a flash-based storage device, a tier 134 may correspond to a SAS-based storage device, and a tier 136 may correspond to an NL-SAS-based storage device. Under such hardware configuration, the tier 132 may be configured with the highest access performance and speed, the tier 134 may be configured with the second highest access performance and speed, and the tier 136 may be configured with relatively low access performance and speed. In the storage pool 130, since automatic tiering processing has not been triggered (e.g., a predetermined time has not arrived, or a predetermined condition has not been met), the first data with the highest data heat (identified by blocks with slant crossed lines) has not been moved to the storage management unit in the tier 132 with the highest access performance and speed. By way of example and not limitation, the tier 132 may have 4 storage management units (i.e., 4 flash storage management units), the tier 134 may have 8 storage management units (i.e., 8 SAS storage management units), and the tier 136 may have 8 storage management units (i.e., 8 NL-SAS storage management units). It should be understood that the number of the storage management units included in each tier may be the same or different, and embodiments of the present disclosure are not limiting in this respect.

As described above, through the automatic tiering mechanism, all or part of the storage data can be moved to the storage management unit of the tier adapted to the heat level due to changes in the data heat. A storage pool 130′ may indicate the distribution of respective data thereon after automatic tiering. The first data with the highest data heat has been moved to the tier 132 with the highest access speed, the second data with the second highest data heat has been moved to the tier 134 with the second highest access speed, and the third data with the relatively low data heat has been moved to the tier 136 with the relatively low access speed. For example, the first data with the highest access frequency in the storage system is located in the storage management unit in the tier 132 with the highest access speed, which can ensure the optimal utilization of storage resources.

It should be understood that limited hardware components are shown in the example environment 100A and limited tiers and storage management units are shown in the example 100B for ease of explanation and ease of illustration. It should be understood that embodiments of the present disclosure are not limited to such arrangements. For example, the example environment 100A may also include other different numbers and types of hardware components, and the example 100B may also include more tiers and a greater number of storage management units.

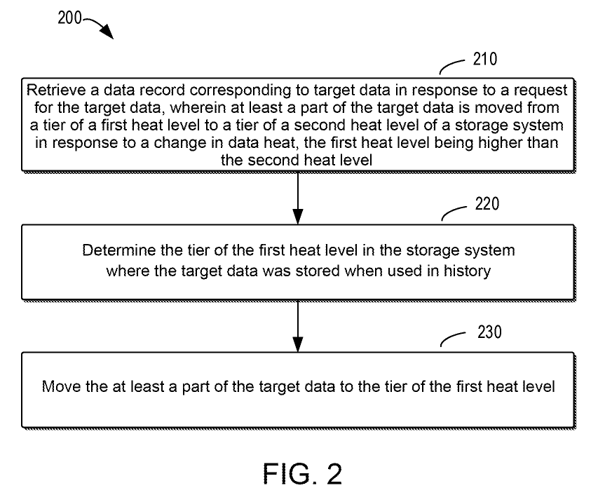

The above description, in conjunction with FIGS. 1A and 1B, illustrates an exemplary hardware configuration of the storage system, as well as the schematic automatic tiering process within the storage pools, according to embodiments of the present disclosure. A flow chart of a method 200 for storage according to an embodiment of the present disclosure will be described below with reference to FIG. 2. In order to effectively solve the problem of I/O performance degradation caused by repeated workloads on storage data whose tiered layout in the storage system has changed due to the automatic tiering mechanism, the method 200 for storage according to an embodiment of the present disclosure is provided.

At block 210, a data record corresponding to target data is retrieved in response to a request for the target data, wherein at least a part of the target data is moved from a tier of a first heat level to a tier of a second heat level of a storage system in response to a change in data heat, the first heat level being higher than the second heat level.

According to an embodiment of the present disclosure, all or part of the target data stored in the storage system may be moved from a tier with a higher heat level to a tier with a lower heat level of the storage system under the action of the automatic tiering mechanism due to a decrease in data heat. In some embodiments, the data heat may correspond to an access frequency of data in the storage system. The above-mentioned tier of the first heat level may indicate or be designed as a storage area in the storage system that is configured to store data with a higher access frequency and configured with a higher access speed, and the above-mentioned tier of the second heat level may indicate or be designed as a storage area in the storage system that is configured to store data with a lower access frequency and configured with a lower access speed.

After being used, the target data per se or one or more parts thereof may have a lowered access frequency. The data inter-tier movement at block 210 may include the target data per se or one or more parts thereof moving from a tier with the relatively high access speed to a tier with the relatively low access speed due to the lowered access frequency, thereby yielding the tier with the relatively high access speed to other data with the relatively high access frequency. At this time, if the request for the target data is received, that is, when the target data needs to be used again, the tiered layout of the target data in the storage system needs to be restored to ensure the read and write performance on the target data. According to an embodiment of the present disclosure, the saved data record of the target data is retrieved and information therein is utilized to facilitate the restoration of the data tiered layout.

At block 220, the tier of the first heat level in the storage system where the target data was stored when used in history is determined. The data record of the target data may have a snapshot attribute or a log attribute, and may record layout information and heat information of the target data in the storage system when it was used in history, so as to indicate which tier or tiers in the storage system the target data may have been distributed in the past and the heat level(s) of the tier(s). According to an embodiment of the present disclosure, it is possible to determine through the data record of the target data which tier in the storage system a corresponding part of the target data was distributed in when it was used in history (e.g., the last time or the time in history when its tiered layout was determined to be a desired tiered layout) and the heat level of the tier.

At block 230, the at least a part of the target data is moved to the tier of the first heat level. After determining, through the data record of the target data, which tier the corresponding part of the target data was distributed in when it was used in history and the heat level of the tier, the target data per se or one or more parts thereof associated with the change in data heat are moved from a current tier with an access speed disadvantage back to the determined tier with an access speed advantage (also referred to as a target tier herein) so as to achieve the desired data tiered layout.

According to an embodiment of the present disclosure, a record-based cross-tier data movement strategy is provided, which can restore the desired data tiered layout according to the data record when repeated workloads need to use stored data again, thereby speeding up data access. Through this strategy, in an automatic tiered storage system, storage data can be easily switched between different tiers without manually moving the data across different tiers.

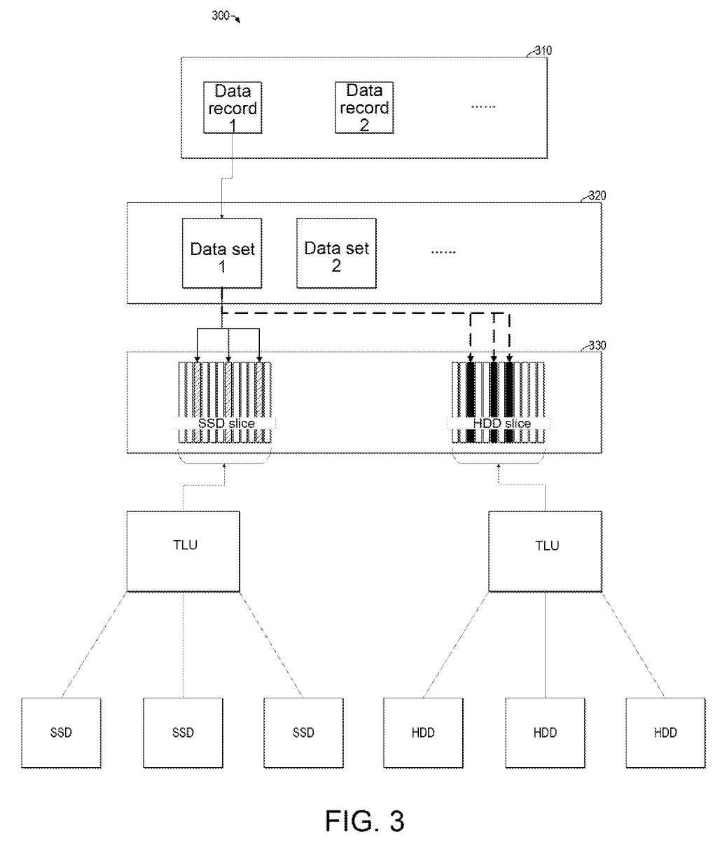

FIG. 3 illustrates an example of a moving process 300 of a record-based cross-tier data movement strategy according to an embodiment of the present disclosure. The moving process 300 will be explained by taking machine learning model training as an example in conjunction with FIG. 3. When it is required to run a training job for a machine learning model, training is typically enabled with an optimized data layout to speed up the job. For example, stored training data may be located in a storage area with higher access performance (e.g., an SSD tier in FIG. 3) in the storage system, rather than a storage area with lower access performance (e.g., HDDs in FIG. 3).

However, data movement of the training data between tiers is managed by automatic tiering algorithms and/or strategies. After a training workload is completed, the tiered layout of the training data may have changed due to the automatic tiering mechanism. For example, because the heat of the entire or a part of the training data decreases, the data is moved to a tier with a lower heat level. The access performance of the tier with the lower heat level is lower (e.g., it has relatively low read and write speeds). In this case, in response to repeated training workloads, when the training job needs to be run again using the training data, the I/O performance during the training job may be degraded because the optimal tiered layout of the training data has been changed. In addition to the training jobs for the machine learning model, application scenarios that require reuse of data and/or data sets stored in storage systems (e.g., data analysis and visualization, strategy optimization, etc.) will face the same or similar degradation effects as mentioned above. To this end, the record-based cross-tier data movement strategy according to an embodiment of the present disclosure is provided.

As shown in FIG. 3, the moving process 300 may involve three levels, namely, a data record (also referred to as tiering record herein) manager 310, a file tier 320, and a storage pool 330, wherein SSD slices in the storage pool 330 may correspond to a plurality of SSDs via corresponding TLUs, and HDD slices in the storage pool 330 may correspond to a plurality of HDDs via corresponding TLUs. It should be understood that the storage pool 330 in FIG. 3 is established on both the SSDs and the HDDs, which is exemplary and not restrictive. For example, a logic storage space may also be established, for example, on the above-mentioned flash memory, SAS, and NL-SAS.

On the data record manager 310 side, a plurality of data records may be included. When executing a target task, a task job of the target task may determine a desired tiered layout of the target data in the storage pool 330 through corresponding data records. In some embodiments, the target data may be training data for performing a target task based on machine learning (e.g., classification, prediction, etc.), which is used to train a machine learning model corresponding to the target task (also referred to as a target model herein) to meet performance requirements. The training job for the machine learning model may determine a desired tiered layout of a data set 1 in the storage pool 330 through a data record 1 corresponding to the requested target data (assuming, for example, the data set 1 illustrated in the figure).

On the file tier 320 side, a plurality of data sets may be included. The file tier 320 is user-oriented. For example, for a user, the data set 1 may be viewed as a whole, and individual data therein may be presented sequentially. On the storage pool 330 side, the individual data of the data set 1 may be stored on non-continuous slices of the same tier, or may be stored across tiers. For example, part of data 1 is distributed on SSD slices, and the other part is distributed on HDD slices.

According to an embodiment of the present disclosure, the data record may indicate respective tiers in the storage system where respective parts of the data was stored when used in history (e.g., the last time or the time in history when a tiered layout thereof was determined to be a desired tiered layout) and the heat levels of the tiers. Each tier in the automatic tiered storage system may include one or more storage management units of the storage system for storing data corresponding to respective parts of data, wherein examples of the storage management units may include, but are not limited to, slices. It should be understood that embodiments of the present disclosure do not limit the sizes of the slices.

By way of example and not limitation, the data record 1 corresponding to the data set 1 may indicate a tiered layout of the data set 1 on SSD slices in the storage pool 330 during the previous machine model training (e.g., slices identified by the narrow blocks with slant crossed lines, as shown in FIG. 3). In other words, as the desired tiered layout, various parts of the data set 1 are distributed on the SSD tier composed of the SSD slices to provide access speed guarantees during training. However, after the training is finished, since an access frequency for the data set 1 decreases, they are migrated from the SSD slices to HDD slices (e.g., slices identified by black narrow blocks, as shown in FIG. 3) to save the storage cost.

When repeated workloads (e.g., repeated training jobs) need to use the data set 1 again, if various parts of the data set 1 are still distributed on the HDD slices, the progress of the training process may be degraded due to the relatively low access speed of the HDD slices. Such repeated training jobs may be due to model parameter tuning, model or algorithm changes, different machine learning tasks but using the same training data, etc. To avoid such degradation, it is necessary to restore the tiered layout of the data set 1 on the SSD slices in the storage pool 330 during the previous machine model training. That is, the various parts of the data set 1 are moved from the HDD tier back to the SSD tier.

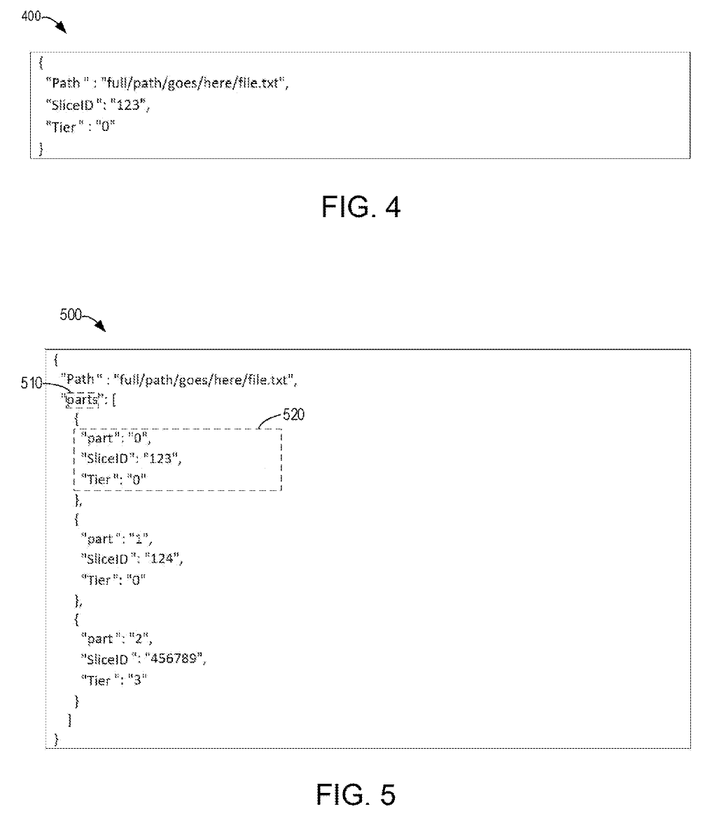

According to an embodiment of the present disclosure, in the process of moving the target data from the current tier with the access speed disadvantage back to the target tier with the access speed advantage, data corresponding to the target data per se or one or more parts thereof whose data heat has changed can be stored in a target storage management unit in the target tier, the target storage management unit has a corresponding heat level of the target tier, and the target storage management unit is different from the storage management unit in which the target data per se or one or more parts thereof whose data heat has changed were stored when they were used in history. For example, in the process of moving the various parts of the data set 1 from the HDD tier back to the SSD tier, the various parts of the data set 1 may be stored on the SSD slices in the SSD tier, and the SSD slices used for storage in the back moving process (e.g., slices identified by white narrow blocks among the plurality of SSD slices shown in the figure, as shown in FIG. 3) may be different from the SSD slices used for storage last time (e.g., slices identified by narrow blocks with slant crossed lines among the plurality of SSD slices shown in the figure, as shown in FIG. 3). In this way, the high efficiency of storage management unit allocation is promoted. The data record according to embodiments of the present disclosure will be described below in further detail with reference to FIGS. 4 and 5.

FIG. 4 illustrates an example 400 of a data record according to an embodiment of the present disclosure. The sizes of files stored in the storage system may be different. According to an embodiment of the present disclosure, when the size of the target data is smaller than or equal to the unit size of the storage management unit, the data record may include at least one of the following: a path of the target data, an identifier of the corresponding storage management unit for the target data, and the corresponding heat level of the tier to which the corresponding storage management unit belongs.

As shown in the example 400 of FIG. 4, the data record of the target data may include the path via which the target data may be accessed. In some embodiments, the target data may be of a text type, an image type, an audio or video type, etc. A slice identifier may indicate on which slice in the storage system the target data is located. Since the size of the target data is relatively small, only one slice may be utilized for the target data. In addition, the tier (identifier) may indicate the heat level of the tier to which the slice belongs. In some embodiments, the heat level may be indicated by an integer number, such as 0-3 for a total of four levels.

FIG. 5 illustrates another example 500 of a data record according to an embodiment of the present disclosure. According to an embodiment of the present disclosure, when the size of the target data is larger than the unit size of the storage management unit, the data record may include at least one of the following: a path of the target data, a first identifier of a corresponding part in a plurality of parts of the target data, a second identifier of the corresponding storage management unit for the corresponding part, and the corresponding heat level of the tier to which the corresponding storage management unit belongs.

As shown in the example 500 of FIG. 5, the target data is divided into a plurality of parts to be scattered in a plurality of slices because it is large. A part division identifier 510 may indicate that the target data has been divided into a plurality of parts. Taking a data record 520 of the first part of the target data (the part identifier is “0”) as an example, it may include a path via which the first part of the target data may be accessed. A slice identifier may indicate on which slice in the storage system the first part of the target data is located. In addition, the tier (identifier) may indicate the heat level of the tier to which the slice belongs. The data records of other parts are similar and will not be repeated here.

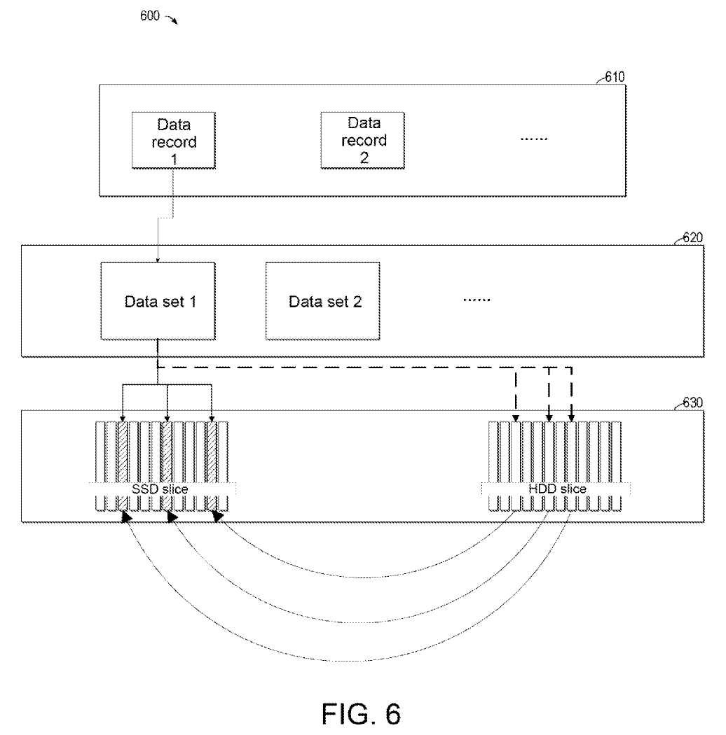

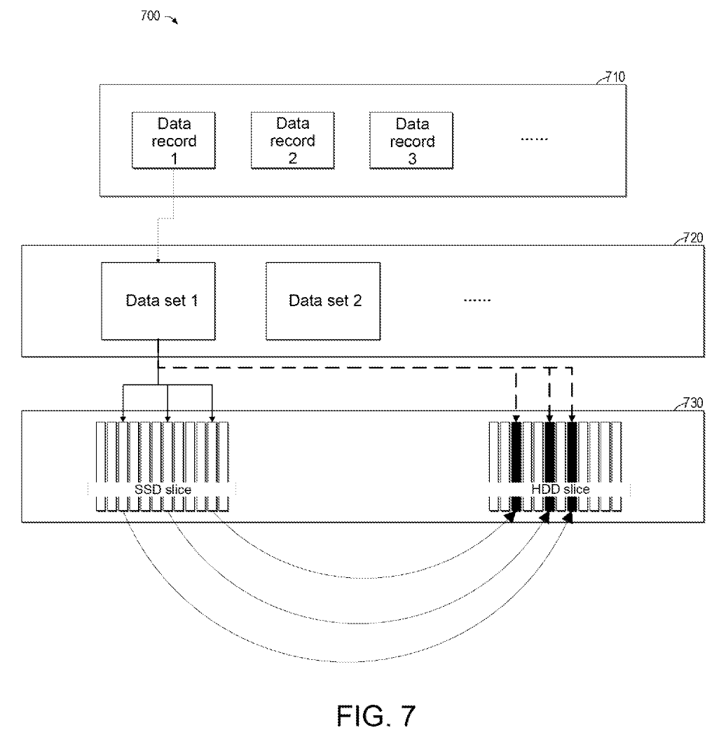

FIG. 6 illustrates an example of a record-based restore process 600 of a data tiered layout according to an embodiment of the present disclosure. A data record 1 at the data record manager corresponding to the data set 1 in the file tier 620 may indicate a tiered layout of the data set 1 on SSD slices of a storage pool 630 during the previous machine model training (e.g., slices identified by narrow blocks with slant crossed lines, as shown in FIG. 6). For example, when the data set 1 needs to be used for training again, various parts of the data set 1 may be moved from HDD slices in an HDD tier back to the SSD slices in the SSD tier based on the data record of the data set 1 on the data record manager 610 side (hereinafter, this data record is referred to as a first data record for convenience of distinction), as shown by curved arrows in FIG. 6.

According to an embodiment of the present disclosure, before the target data per se or one or more parts of the target data with changed data heat are moved to the target tier, a data record indicating a tiered layout in which the target data is currently stored in the storage system (hereinafter, for convenience of distinction, this data record is referred to as a second data record) may be generated, and the tiered layout indicates which tier or tiers currently store the target data (the target data has been moved entirely to a disadvantage tier, or part of the target data remains in an advantage tier and another part is moved to the disadvantage tier) and the heat level of the tier. For example, before moving various parts of the data set 1 back to the SSD tier, the second data record may be generated to indicate the tier in the storage system where the various parts of the data set 1 are currently stored and the heat level of the tier (i.e., HDD tier).

FIG. 7 illustrates an example of a record-based data back migration process 700 according to an embodiment of the present disclosure. As described above, before the data tiered layout is restored, the second data record of the layout information and heat information of the target data on the tier with the access speed disadvantage may be retained. In order to save storage resources, after the use of the target data on the tier with the access speed advantage is completed, the target data may be migrated from the tier with the access speed advantage back to the tier with the access speed disadvantage based on the second data record of the target data.

According to an embodiment of the present disclosure, after the use of the target data on the target tier is completed, based on the second data record, the target data per se or one or more parts thereof whose data heat has changed may be moved from the target tier (i.e., the tier with the access speed advantage) back to the original tier (i.e., the tier with the access speed disadvantage). For example, based on the second data record of a data set 1 of a file tier 720 (which may be stored on a data record manager 710 side, such as a data record 3), various parts of the data set 1 may be migrated from SSD slices in an SSD tier in a storage pool 730 back to HDD slices in an HDD tier, as shown by curved arrows in FIG. 7. In this way, the utilization rate of the storage resources in the storage system may be increased.

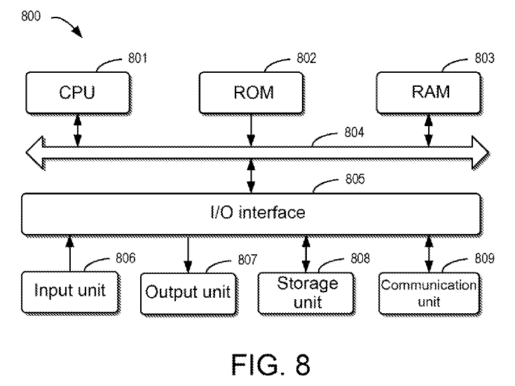

FIG. 8 illustrates a block diagram of an example device 800 that may be used for implementing some embodiments according to the present disclosure. As shown in FIG. 8, the device 800 includes a central processing unit (CPU) 801 that may perform various appropriate actions and processing according to computer program instructions stored in a read-only memory (ROM) 802 or computer program instructions loaded from a storage unit 808 to a random access memory (RAM) 803. Various programs and data required for the operation of the device 800 may also be stored in the RAM 803. The CPU 801, the ROM 802, and the RAM 803 are connected to each other through a bus 804. Input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disk; and a communication unit 809, such as a network card, a modem, and a wireless communication transceiver. The communication unit 809 allows the device 800 to exchange information/data with other devices via a computer network, such as the Internet, and/or various telecommunication networks.

The various processes and processing described above, such as the method 200, may be performed by the CPU 801. For example, in some embodiments, the method 200 may be implemented as a computer software program that is tangibly included in a machine-readable medium such as the storage unit 808. In some embodiments, part or all of the computer program may be loaded and/or installed onto the device 800 via the ROM 802 and/or the communication unit 809. When the computer program is loaded into the RAM 803 and executed by the CPU 801, one or more actions of the method 200 described above may be implemented.

Illustrative embodiments of the present disclosure include a method, apparatus, system, and/or computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or a flash memory), a static random access memory (SRAM), a portable compact disc read-only memory (CD-ROM), a digital versatile disc (DVD), a memory stick, a floppy disk, a mechanical encoding device such as a punch card or protrusions in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming languages such as Smalltalk, C++, or the like, and conventional procedural programming languages such as the C language or similar programming languages. The computer-readable program instructions can be executed entirely on a user computer, executed partly on a user computer, executed as a separate software package, executed partly on a user computer and partly on a remote computer, or executed entirely on a remote computer or a server. In a case where a remote computer is involved, the remote computer can be connected to a user computer through any kind of networks, including a local area network (LAN) or a wide area network (WAN), or can be connected to an external computer (e.g., connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product according to the embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means for implementing the functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored thereon includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Many modifications and variations will be apparent to those of ordinary skill in the art without departing from the scope and spirit of the embodiments described. The selection of terms used herein is intended to best explain the principles and practical applications of the various embodiments and their associated technical improvements, in order to enable persons of ordinary skill in the art to understand the embodiments disclosed herein.

What is claimed is:

1. A method for storage, comprising:
retrieving a data record corresponding to target data in response to a request for the target data, wherein at least a part of the target data is moved from a tier of a first heat level to a tier of a second heat level of a storage system in response to a change in data heat, the first heat level being higher than the second heat level;
determining, based on the retrieved data record, the tier of the first heat level in the storage system where the target data was stored when used in history; and
moving the at least a part of the target data to the tier of the first heat level.

2. The method according to claim 1, wherein the data heat corresponds to an access frequency of data in the storage system,
the tier of the first heat level indicates a storage area in the storage system that is configured to store data of a first access frequency and configured with a first access speed, and
the tier of the second heat level indicates a storage area in the storage system that is configured to store a second access frequency and configured with a second access speed, the first access frequency being higher than the second access frequency, and the first access speed being faster than the second access speed.

3. The method according to claim 1, wherein:
the data record indicates a corresponding tier in the storage system where a corresponding part of the target data was stored when used in history and a heat level of the corresponding tier, wherein the corresponding tier comprises at least one storage management unit of the storage system for storing data corresponding to the corresponding part.

4. The method according to claim 3, wherein when a size of the target data is smaller than or equal to a unit size of the storage management unit, the data record comprises at least one of:
a path of the target data;
an identifier of a corresponding storage management unit for the target data; and
a corresponding heat level of a tier to which the corresponding storage management unit belongs.

5. The method according to claim 3, wherein when a size of the target data is larger than a unit size of the storage management unit, the data record comprises at least one of:
a path of the target data;
a first identifier of a corresponding part of a plurality of parts of the target data;
a second identifier of a corresponding storage management unit for the corresponding part; and
a corresponding heat level of a tier to which the corresponding storage management unit belongs.

6. The method according to claim 1, wherein the tier of the first heat level is a target tier, and moving the at least a part of the target data to the target tier comprises:
storing data corresponding to the at least a part of the target data in a target storage management unit in the target tier, wherein the target storage management unit has the first heat level of the target tier, and the target storage management unit is different from a storage management unit where the at least a part of the target data was stored when used in history.

7. The method according to claim 1, wherein the data record is a first data record when the target data was last used, and wherein before moving the at least a part of the target data to the tier of the first heat level, the method further comprises:
generating a second data record to indicate a tiered layout in which the target data is currently stored in the storage system.

8. The method according to claim 7, further comprising:
after use of the target data on the tier of the first heat level is completed, moving the at least a part of the target data from the tier of the first heat level back to the tier of the second heat level based on the second data record.

9. The method according to claim 1, wherein:
the target data is training data for performing a target task based on machine learning, and
the target data is used to train a target model corresponding to the target task.

10. An electronic device, comprising:
a processor; and
a memory coupled to the processor and storing instructions that, when executed by the processor, cause the electronic device to perform actions comprising:
retrieving a data record corresponding to target data in response to a request for the target data, wherein at least a part of the target data is moved from a tier of a first heat level to a tier of a second heat level of a storage system in response to a change in data heat, the first heat level being higher than the second heat level;
determining, based on the retrieved data record, the tier of the first heat level in the storage system where the target data was stored when used in history; and
moving the at least a part of the target data to the tier of the first heat level.

11. The electronic device according to claim 10, wherein the data heat corresponds to an access frequency of data in the storage system,
the tier of the first heat level indicates a storage area in the storage system that is configured to store data of a first access frequency and configured with a first access speed, and
the tier of the second heat level indicates a storage area in the storage system that is configured to store a second access frequency and configured with a second access speed, the first access frequency being higher than the second access frequency, and the first access speed being faster than the second access speed.

12. The electronic device according to claim 10, wherein:
the data record indicates a corresponding tier in the storage system where a corresponding part of the target data was stored when used in history and a heat level of the corresponding tier, wherein the corresponding tier comprises at least one storage management unit of the storage system for storing data corresponding to the corresponding part.

13. The electronic device according to claim 12, wherein when a size of the target data is smaller than or equal to a unit size of the storage management unit, the data record comprises at least one of:
a path of the target data;
an identifier of a corresponding storage management unit for the target data; and
a corresponding heat level of a tier to which the corresponding storage management unit belongs.

14. The electronic device according to claim 12, wherein when a size of the target data is larger than a unit size of the storage management unit, the data record comprises at least one of:
a path of the target data;
a first identifier of a corresponding part of a plurality of parts of the target data;
a second identifier of a corresponding storage management unit for the corresponding part; and
a corresponding heat level of a tier to which the corresponding storage management unit belongs.

15. The electronic device according to claim 10, wherein the tier of the first heat level is a target tier, and moving the at least a part of the target data to the target tier comprises:
storing data corresponding to the at least a part of the target data in a target storage management unit in the target tier, wherein the target storage management unit has the first heat level of the target tier, and the target storage management unit is different from a storage management unit where the at least a part of the target data was stored when used in history.

16. The electronic device according to claim 10, wherein the data record is a first data record when the target data was last used, and wherein before moving the at least a part of the target data to the tier of the first heat level, the actions further comprise:
generating a second data record to indicate a tiered layout in which the target data is currently stored in the storage system.

17. The electronic device according to claim 16, wherein the actions further comprise:
after use of the target data on the tier of the first heat level is completed, moving the at least a part of the target data from the tier of the first heat level back to the tier of the second heat level based on the second data record.

18. The electronic device according to claim 10, wherein:
the target data is training data for performing a target task based on machine learning, and
the target data is used to train a target model corresponding to the target task.

19. A computer program product, the computer program product being tangibly stored on a non-transitory computer-readable medium and comprising machine-executable instructions, wherein the machine-executable instructions, when executed by a machine, cause the machine to perform actions comprising:
retrieving a data record corresponding to target data in response to a request for the target data, wherein at least a part of the target data is moved from a tier of a first heat level to a tier of a second heat level of a storage system in response to a change in data heat, the first heat level being higher than the second heat level;
determining, based on the retrieved data record, the tier of the first heat level in the storage system where the target data was stored when used in history; and
moving the at least a part of the target data to the tier of the first heat level.

20. The computer program product according to claim 19, wherein the data heat corresponds to an access frequency of data in the storage system,
the tier of the first heat level indicates a storage area in the storage system that is configured to store data of a first access frequency and configured with a first access speed, and
the tier of the second heat level indicates a storage area in the storage system that is configured to store a second access frequency and configured with a second access speed, the first access frequency being higher than the second access frequency, and the first access speed being faster than the second access speed.
